(19) United States
(12) Patent Application Publication
(10) Pub. No.: US 2016/0044285 A1
(43) Pub. Date: Feb. 11, 2016

(54) Real Time Imaging and Wireless Transmission System and Method for Material Handling Equipment

(71) Applicant: Convoy Technologies, LLC, Newport Beach, CA (US)

(72) Inventors: Blake Albert Gasca, Aliso Viejo, CA (US); Troy Douglas Scott Howell, Mantorville, MN (US)

(21) Appl. No.: 14/821,392

(22) Filed: Aug. 7, 2015

Related U.S. Application Data
(60) Provisional application No. 62/035,146, filed on Aug. 8, 2014.

(51) Int. Cl. H04N 7/18; B60R 1/00

(52) U.S. Cl. CPC H04N 7/183; B60R 1/00; B60R 2300/80

(57) ABSTRACT

Systems and methods provide at least one of an image, video and audio for material handling equipment including capturing by an image capturing device at least one of an image, video and audio in an area proximate to a grasping portion of a material handling equipment, communicating at least one of the captured image, video and audio to a transceiver, and establishing communication between the image capturing device and transceiver to output at least one of the captured image, video, and audio for viewing by an operator of the material handling equipment on an image display device.

### CROSS-REFERENCE TO RELATED APPLICATION

This application claims benefit under 35 U.S.C. §119(e) of U.S. provisional patent applications Ser. No. 62/035,146 filed Aug. 8, 2014, the disclosure of which is hereby incorporated by reference in its entirety.

### BACKGROUND OF THE INVENTION

1. Field of the Invention

Generally, exemplary embodiments of the present invention relate to the fields of hardware and software solutions for wirelessly transmitting images and/or a video in real time from material handling equipment, and in particular images that facilitate operation of a grasping device attached to a construction, utility or refuse collection vehicle for handling containers or different materials during collection/construction efforts.

2. Discussion of the Background of the Invention.

Conventional material handling devices, such as specialty trucks 100 illustrated in FIGS. 1A and 1B typically have a mechanism for lifting, moving and tipping a container or object of interest, such as a mechanism comprising a grasping device 120 attached to a large movable arm 110. The grasping device often has a pair of spaced and opposed mechanical hands 130 that can grasp and release a container (not shown) by closing and opening hands 130 through operation by one or more actuating devices, such as hydraulic cylinders, controlled by controllers typically provided in a driver's cabin 140.

While there are various imaging and video equipment available for passenger vehicles and trucks, such as GPS-based navigation systems, entertainment systems, and back-up camera systems (including wireless systems), there are no tools available specifically for material handling equipment to provide visual guidance or information to operators of such equipment to facilitate accurate grasping and releasing of the material being handled.

Accordingly, conventional methods and techniques for such operations have at least the drawbacks of requiring, for example, another person to observe the grasping and/or releasing function and direct the equipment operator accordingly, or multiple attempts by the operator to properly grasp and/or release the material being handled.

### SUMMARY OF THE INVENTION

Exemplary embodiments of the present invention address at least the above problems and/or disadvantages and provide at least the advantages described below.

Exemplary embodiments of the present invention provide systems and methods for providing at least one of an image, video and audio for material handling equipment including capturing by an image capturing device at least one of an image, video and audio in an area proximate to a grasping portion of a material handling equipment, communicating at least one of the captured image, video and audio to a transceiver, and establishing communication between the image capturing device and the transceiver to output at least one of the captured image, video, and audio for viewing by an operator of the material handling equipment on an image display device.

According to an exemplary implementation of the embodiments of the present invention, communication includes wireless communication, and the output at the least one of the captured image, video, and audio is for viewing by the operator of the material handling equipment in real time.

According to another exemplary implementation of the embodiments of the present invention, the grasping portion includes opposed hands to facilitate grasping, and the image, video and audio are captured essentially from a central support axis of the opposed hands.

According to a further exemplary embodiment of the present invention, material handling equipment includes an arm, and the grasping portion travels along the arm, the transceiver is fixedly disposed on the arm, the image capturing device is disposed on the grasping portion, and communication between the transceiver and the image capturing device is wired and/or wireless.

According to yet another exemplary implementation of the embodiments of the present invention, the image displaying device includes at least one of a smartphone, a personal display device, a personal computing device, or a tablet in wired and/or wireless communication with the transceiver. In an exemplary implementation, the image display device can include the transceiver.

According to a further exemplary embodiment of the present invention, non-transient computer readable medium and associated computer implemented processing can be provided to selectively store and retrieve images and/or video obtained during a work process, whereby valuable information can be available for subsequent review, analysis and/or any record-keeping purposes.

According to an exemplary implementation of the embodiments of the present invention, images can be transmitted wirelessly from a vehicle's exterior equipment to a receiver located in a driver's cabin of the vehicle.

According to another exemplary implementation of the embodiments of the present invention, transmitted images and/or video can be stored, for example, on a local non-transient storage medium associated with a receiver, on a designated server, or on a cloud server. In yet another exemplary implementation, a streaming video can be transmitted directly or indirectly (such as via a server) to a portable device (for example an iOS or Android type mobile communication device) for viewing and/or storage thereon.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIGS. 1A and 1B are generalized drawings of conventional material handling devices, such as specialty trucks.

FIGS. 2A and 2B illustrates a system including a camera and material handling equipment having the camera deployed thereon according to exemplary embodiments of the present invention.

FIG. 3A, 3B and 3C illustrates an example of components and configuration thereof with respect to material handling equipment for implementing methodology and functionality in accordance with exemplary embodiments of the present invention.

FIG. 4 illustrates a system and components utilizing wireless configuration deployed with respect to material handling equipment according to an exemplary embodiment of the present invention.

FIG. 5 is a generalized diagram illustrating an example of signal paths and system components according to exemplary embodiments of the present invention.

### DETAILED DESCRIPTION OF EXEMPLARY EMBODIMENTS

Referring now to the drawings, wherein like reference numerals designate identical or corresponding parts throughout the several views, non-limiting examples of implementations of certain exemplary embodiments of the present invention are shown in schematic detail to aid in the description of technology associated therewith. Any specific or relative dimensions or measurements provided in the drawings are exemplary and not intended to limit the scope or content of the inventive design or methodology as understood by artisans skilled in the relevant field of invention.

The matters defined in the description such as a detailed construction and elements are nothing but the ones provided to assist in a comprehensive understanding of the invention. Accordingly, those of ordinary skill in the art will recognize that various changes and modifications of the embodiments described herein can be made without departing from the scope and spirit of the invention. Also, well-known functions or constructions are omitted for clarity and conciseness. Certain exemplary embodiments of the present invention are described below in the context of commercial applications, or with reference to drawings containing certain numerical values for illustrating examples of dimensional relationships between parts shown therein. Such exemplary implementations are not intended to limit the scope of the present invention, which is defined in the appended claims.

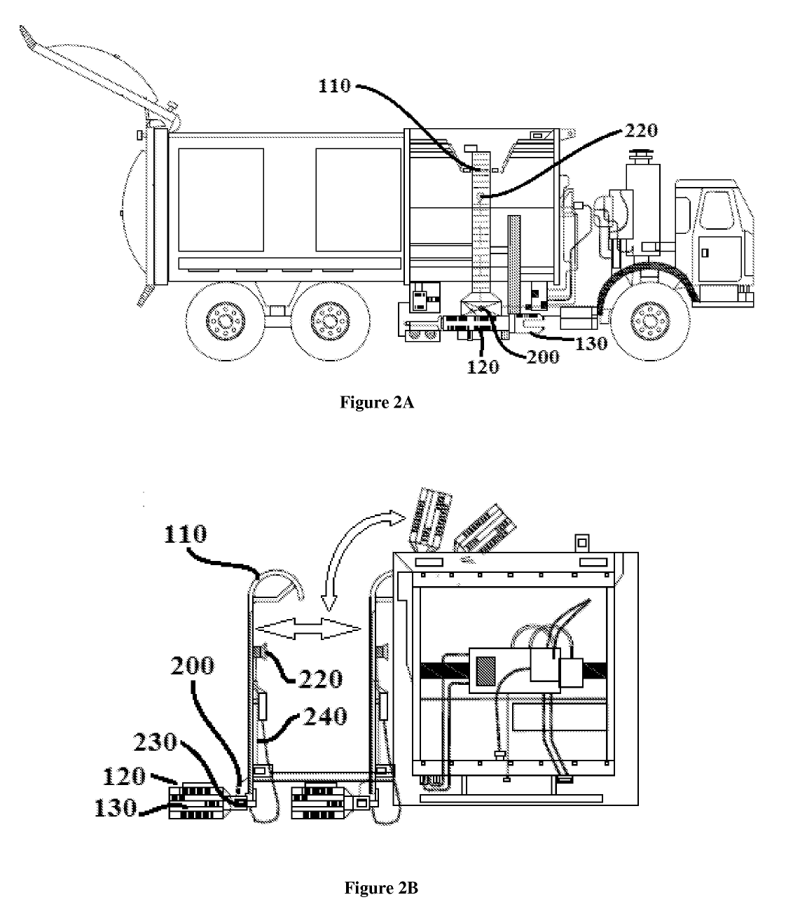

Exemplary embodiments of the present invention provide a device and method, as illustrated in FIGS. 2A through 5, which can assist drivers and operators of material handling equipment by providing real time images and/or video from a specific work location, thereby reducing or eliminating conventionally required manual intervention or additional personnel.

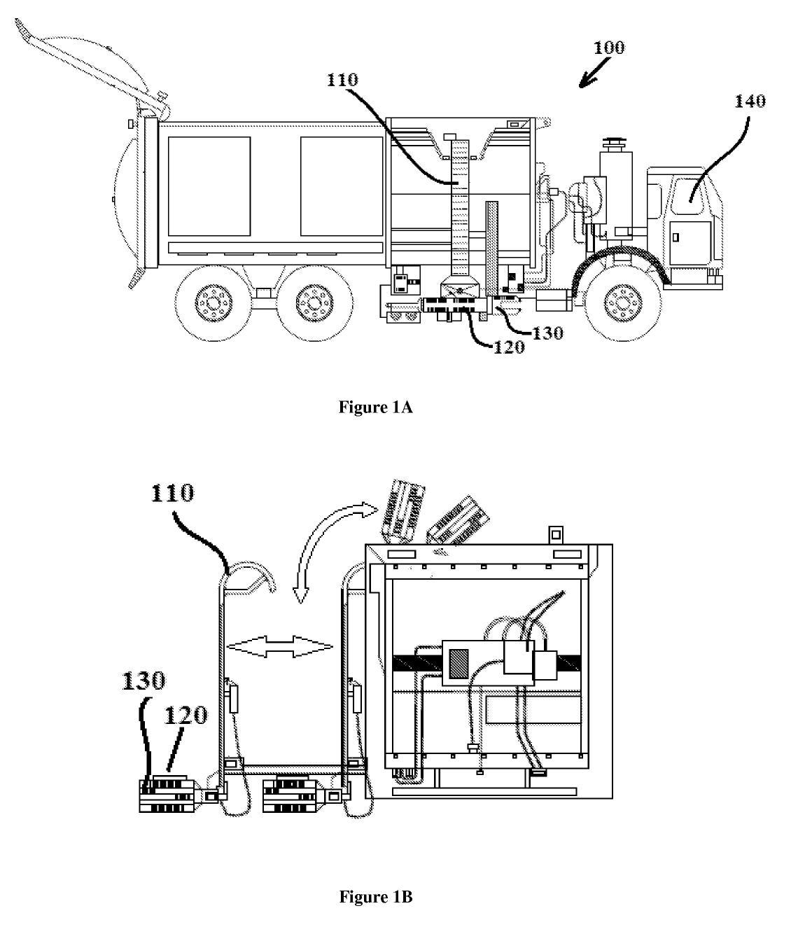

Referring to FIGS. 2A and 2B, an HD camera 200 can be placed on an arm 110 which can be, or form a part of, a fully retractable material handling apparatus for grasping and releasing containers or objects as shown in FIGS. 1A and 1B. As in the example of FIGS. 1A and 1B, arm 110 has a grasping device 120 with a pair of spaced, opposed hands 130 pivotally connected at a central support axis 230. Hands 130 can be shaped to fit around containers or objects of different shapes. For example, hands 130 can be configured to pivot between an open or retracted position and a closed or grasping position by operating actuators, which may be controlled by controllers disposed for example in a driver's cabin.

According to further exemplary implementation of the present invention as illustrated in FIGS. 2A and 2B, a camera 200 is positioned on an arm 110 of the material handling equipment to provide the highest visibility of a specific work location. An example of such positioning of camera 200 is at a point proximal to a central support axis 230 of the opposed hands 130 to facilitate viewing of a container while the hands 130 are pivoted between an open and a closed position to grasp or release the container. Camera 200 can be an HD-type camera.

According to yet further exemplary implementation of the present invention as further illustrated in FIG. 2A and 2B, a wireless encoder/transmitter 220 associated with camera 200 is positioned on an arm 110 of the material handling equipment to provide the best interference-free transmission of images and/or video captured by camera 200, which are provided to encoder/transmitter 220 from camera 200 via a link 240, which illustrates a wired or wireless communication between encoder/transmitter 220 and camera 200.

According to en exemplary implementation of embodiments of the present invention, camera 200 may include video capture capability, and provide video transmission and/or recording capability. According to yet another exemplary implementation, audio recording and/or transmission capability may be provided integrally in camera 200 or as an additional components disposed, for example, in proximity to camera 200.

According to a further exemplary embodiment of the present invention, non-transitory computer readable medium and associated computer implemented processing can be provided to selectively store and retrieve images and/or video obtained during a work process, whereby valuable information can be available for subsequent review, analysis and/or any record-keeping purposes.

According to an exemplary implementation of the embodiments of the present invention, images can be transmitted wireles sly from a vehicle's exterior equipment to a receiver located in a driver's cabin of the vehicle.

According to another exemplary implementation of the embodiments of the present invention, transmitted images and/or video can be stored, for example, on a local non-transitory storage medium associated with a receiver, on a designated server, or on a cloud server. In yet another exemplary implementation, a streaming video can be transmitted directly or indirectly (such as via a server) to a portable device (for example an iOS or Android type mobile communication device) for viewing and/or storage thereon.

According to another exemplary implementation of the embodiments of the present invention, transmitted images and/or video can be retrieved via internet, for example, through a secure (such as a password protected) website.

According to an exemplary embodiment of the present invention, a system can include the following exemplary, non-limiting components:
High Definition (HD) Camera
Encoder/Transmitter (Wireless)
Receiver (Wireless)
Router
Software/Hardware: monitoring analytics, iOS and Android apps, QR code reading applications for the purpose of identifying a customer's location & status of handled material/equipment as well as the status of that customer's account. By using Convoy application, Customers will be able to opt-in for live alerts and mobile bill pay when service has been completed or account balance needs to be addressed before continuing with service.

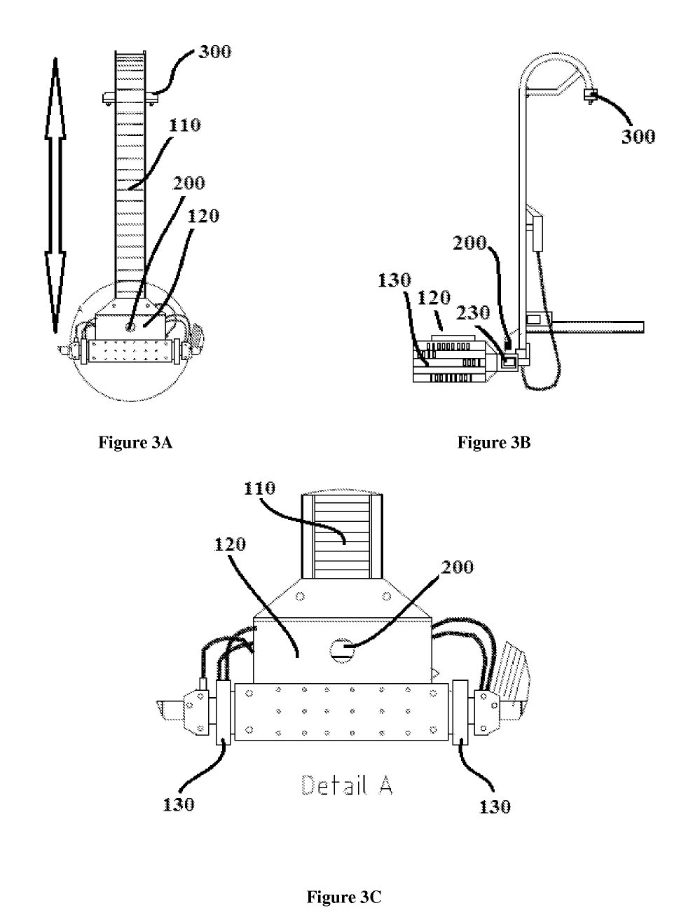

Referring to FIGS. 3A, 3B and 3C, camera 200 is positioned at an essentially central point of grasping device 120 with respect to hands 130, as shown in the detail of FIG. 3C. Camera 200 can advantageously travel along the arm 110 with the grasping device 120 through the grasping and releasing operation of device 120. In the example of FIGS. 3A, 3B and 3C, communication link between camera 200 and encoder/transmitter 300 can be, for example, wireless provided that camera 200 has wireless communication capability. According to exeplary implementation of certain embodiments of the present invention as illustrated in FIG. 3B, encoder/transmitter 300 can be disposed in an alternative position, which may facilitate a better communication link for transmitting images, video, and/or sound from camera 200, and/or for transmitting commands to camera 200.

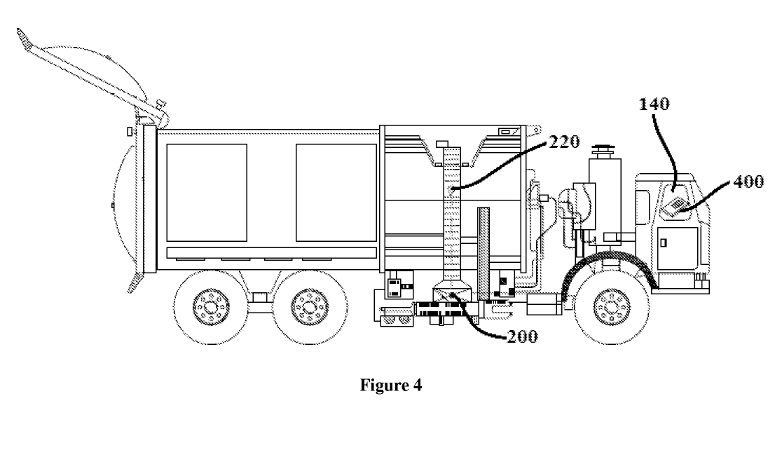

According to yet another exemplary implementation of the embodiments of the present invention as further illustrated in FIG. 4, a wireless encoder/transmitter 220 associated with camera 200 can transmit images, video, and/or audio data received from camera 200 to a receiver 400 positioned inside the driver's cabin 140 for storage and/or viewing thereon selectively and/or in real time.

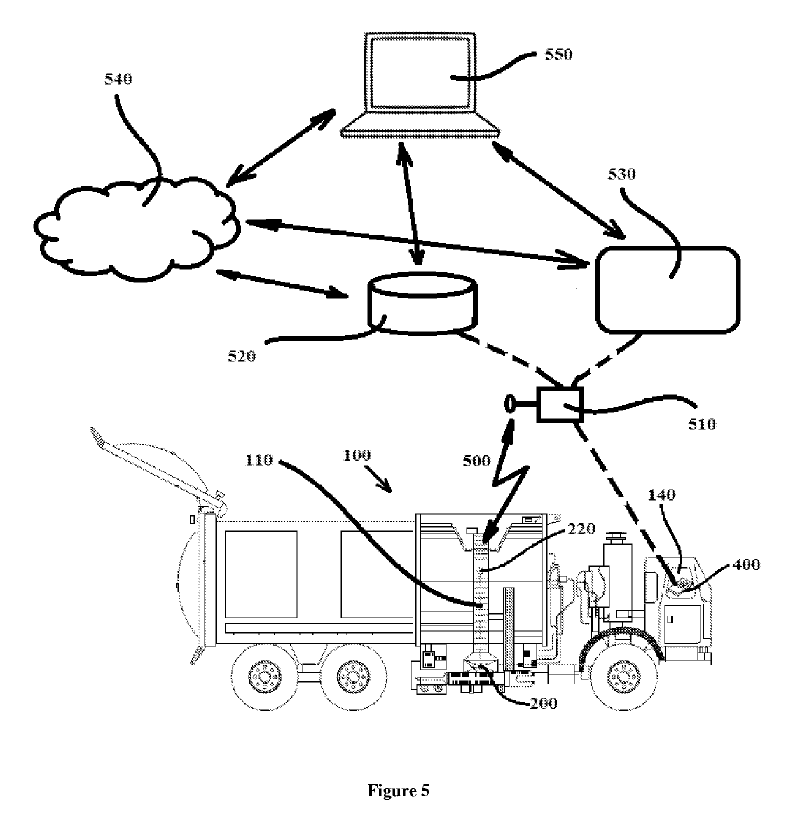

According to a yet further exemplary implementation of the embodiments of the present invention as diagrammatically shown in FIG. 5, wireless communication capability can be provided by appropriately configured wireless transceiver(s) such as 510. In an exemplary implementation, images from camera 200 can be transmitted wirelessly 500 via encoder/transmitter 220 from a vehicle's exterior equipment 110 to a mobile communication device 400 located in a driver's cabin 140 of the vehicle 100. According to a further exemplary implementation of the embodiments of the present invention, transmitted images and/or video from camera 200 can be stored, for example, locally on a non-transitory storage medium provided in device 400 or removable storage in camera 200 itself, and/or remotely on a designated server 520 and/or on a cloud server 530.

In yet another exemplary implementation, a streaming video can be transmitted directly or indirectly (such as via a server) to a portable or a desktop device 550 (for example an iOS or Android type mobile communication device, or a personal computer) for viewing and/or storage thereon. According to yet another exemplary implementation of the embodiments of the present invention, transmitted images and/or video can be retrieved via internet 540, for example, through a secure (such as a password protected) website.

In an exemplary implementation of the present invention, a camera can comprise the following non-limiting characteristics:

### Optics

Custom Hyperion Lens

T2.8/f/2.7 Natural Wide Angle

145 Degrees @1080P, 960P, 720P

145 Degrees @Still Photos

2× Better Lowlight Sensitivity

In an exemplary implementation of the present invention, image and video quality provided by the camera and associated equipment can comprise the following non-limiting characteristics:
File Type

H.264.MP4
Resolution Options

1080P 60/50/48/30/25/24 fps

960p 60/50/48/30/25/24 fps

720p 120/60/50/48/30/25/24 fps
Still Picture Resolution

16 MP
Format Options

NTSC

PAL

According to another exemplary embodiment of the present invention, audio equipment can be provided, for example, as part of camera equipment or independent thereof. A non-limiting example of audio characteristics includes:
Audio

AAC & AC3 2 Channel Mono

48 kHz, 16 bit, Auto Gain

Internal Mic Omnidirectional

3.5 mm Aux Line-In with Adapter

According to another exemplary embodiment of the present invention, a removable non-transitory memory, such as, for example, a microSDXC of 128 GB, can be provided for integration with camera, transmitter, receiver, or any other system equipment, for storage of image, video and/or audio data.

According to yet other exemplary implementations of the embodiments of the present invention camera features can include the following non-limiting characteristics:
Power

5V-30V

3.5 Hour Rechargeable Battery
Other Features

WiFi, or other suitable near-field radio frequency communication

360 Degree Mountable Design for camera

Aluminum Housing for camera

IP69K environmental rating

Ultra-Lightweight and Compact camera design

Remotely Adjustable Camera Settings

Capable of Integrating with SSV iOS/Android App

According to yet other exemplary implementations of the embodiments of the present invention encoder/transmitter features can include the following non-limiting characteristics:
Micro HDMI
Streaming Resolution Support:

1080i 50/59.94/60

1080p 23.98/24/25/30

1080p 23.98/24/25

720p 50/59.94/60

576p

480p
H.264 Compression: Main & Baseline
Video Bit Rate: 150 kbps to 5 mbps
Built-in scaler & deinterlacer
2.4/5 GHz a/b/g/n MIMO WiFi
Radio Output Power: 40 mW
Audio Compression: AAC-LC, MPEG Layer 2
Embedded Audio (2 channel) (micro HDMI)
Audio Bit Rate: 16 kbps to 256 kbps
6-18V DC input barrel connector
Nominal power consumption: 3.5W
Dimensions: 66×49×17 mm
Weight: <2 Oz

The above-described exemplary embodiments may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well known and available to those having skill in the computer software arts. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. The media may also be a transmission medium such as optical or metallic lines, wave guides, and so on, including a carrier wave transmitting signals specifying the program instructions, data structures, and so on. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

While the present invention has been shown and described with reference to certain exemplary embodiments thereof, it will be understood by those skilled in the art that various changes in form and details may be made therein without departing from the spirit and scope of the present invention as defined by the appended representative claims.

We claim:

1. A device providing at least imaging for material handling equipment comprising:
an image capturing device disposed on a grasping portion of a material handling equipment, said image capturing device capturing an image visible from a perspective of said grasping portion;
a transceiver in communication with said imaging device; and
a receiver in wireless communication with said transceiver,
wherein said receiver outputs said image captured by said image capturing device for viewing by an operator of said material handling equipment on an image display device in real time during operation of said grasping portion of said material handling equipment.

2. The device of claim 1, further comprising an audio capturing device,
wherein said receiver outputs at least one of said image and said audio to an operator of said material handling equipment.

3. The device of claim 1, wherein said image capturing device captures a video stream of images visible from said perspective of said grasping portion, and said receiver outputs said video.

4. The device of claim 3, wherein said receiver outputs said video for viewing by an operator of said material handling equipment in real time during operation of said grasping portion of said material handling equipment.

5. The device of claim 1, wherein said grasping portion comprises opposed hands to facilitate said grasping, and said image capturing device is disposed essentially at a central support axis of said opposed hands.

6. The device of claim 1, wherein said material handling equipment comprises an arm, said grasping portion traveling along said arm, and said transceiver is fixedly disposed on said arm.

7. The device of claim 1, wherein said communication between said transceiver and said image capturing device comprises at least one of wired communication and wireless near-field communication.

8. The device of claim 1, wherein said image displaying device comprises at least one of a smartphone, a personal display device, a personal computing device, or a tablet.

9. The device of claim 8, wherein said image displaying device comprises said receiver.

10. A method for providing at least one of an image, video and audio for material handling equipment comprising:
capturing by an image capturing device at least one of an image, video and audio in an area proximate to a grasping portion of a material handling equipment;
communicating said at least one of said image, video and audio to a transceiver; and
establishing communication between said image capturing device and said transceiver to output at least one of said captured image, video, and audio for viewing by an operator of said material handling equipment on an image display device.

11. The method of claim 10, wherein said communication comprises wireless communication, and said output at said least one of said captured image, video, and audio is for viewing by said operator of said material handling equipment in real time.

12. The method of claim 10, wherein said grasping portion comprises opposed hands to facilitate said grasping, and said capturing comprises capturing at least one of said image, video and audio essentially from a central support axis of said opposed hands.

13. The method of claim 10, wherein:
said material handling equipment comprises an arm,
said grasping portion traveling along said arm,
said transceiver is fixedly disposed on said arm,
said image capturing device is disposed on said grasping portion, and
said establishing communication with said transceiver comprises establishing at least one of a wired and wireless communication between said transceiver and said image capturing device.

14. The method of claim 10, wherein said image displaying device comprises at least one of a smartphone, a personal display device, a personal computing device, or a tablet.

15. The method of claim 14, wherein said establishing communication with said transceiver further comprises establishing at least one of a wired and wireless communication between said transceiver and said image displaying device.

16. A system comprising:
a material handling equipment;
a data capturing device disposed on a grasping portion of said material handling equipment for capturing at least one of said image, video, and audio data from perspective of said grasping portion;
a transceiver in communication with said data capturing device; and
a receiver in communication with said transceiver,
wherein said receiver outputs said at least one of said image, video, and audio data captured by said data capturing device to a data output devices of an operator of said material handling equipment.

17. The system of claim 16, wherein said receiver outputs said at least one of said image, video, and audio data captured by said data capturing device to data output device of said operator of said material handling equipment in real time during operation of said grasping portion of said material handling equipment.

18. The system of claim 16, further comprising a non-transitory storage medium for storage and retrieval of said at least one of said image, video, and audio captured by said data capturing device.

19. The system of claim 16, further comprising a secure or open link for accessing said non-transitory storage medium via a wired or wireless communication for at least one of storage and retrieval of said at least one of said image, video, and audio captured by said data capturing device.

20. The system of claim 16, wherein said data output device comprises at least one of a smartphone, a personal display device, a personal computing device, or a tablet.
